(19) United States
(12) Patent Application Publication
(10) Pub. No.: US 2019/0111610 A1
(43) Pub. Date: Apr. 18, 2019

(54) SURFACE-STRUCTURED POLYMER BODIES AND METHOD FOR THE FABRICATION THEREOF

(71) Applicant: Leibniz-Institut fuer Polymerforschung Dresden e.V., Dresden (DE)

(72) Inventors: Bernhard GLATZ, Dresden (DE); André KNAPP, Radeberg (DE); Andreas FERY, Dresden (DE)

(73) Assignee: Leibniz-Institut fuer Polymerforschung Dresden e.V., Dresden (DE)

(21) Appl. No.: 16/158,386

(22) Filed: Oct. 12, 2018

(30) Foreign Application Priority Data
Oct. 13, 2017 (DE) 10 2017 218 363.2

(51) Int. Cl. B29C 55/16; B29C 59/14; B29C 59/16; B29B 15/10

(52) U.S. Cl. CPC B29C 55/165; B29C 59/14; B29K 2009/00; B29B 15/10; B29C 59/16

(57) ABSTRACT

Surface-structured polymer bodies in which polymer bodies with dimensions of at least ≥100 cm² are present. The surfaces of the bodies are at least partially covered with at least one nano- to micrometer-thick layer, and the layers are physically and/or chemically coupled to the polymer bodies, and the surface of the polymer bodies with the layers is at least partially deformed. The deformation is periodic within a deformation type and the arrangement of multiple different deformation types on a polymer body is anisotropic or isotropic, and the elastic modulus of the material of the polymer body is less than the elastic modulus of the layer materials.

The invention concerns the field of polymer chemistry and relates to surface-structured polymer bodies such as those which can, for example, be used in solar cells or as anti-fouling films in medical technology, for preventing the adhesion of viruses and/or bacteria, or for modifying tribological properties such as, for example, minimizing friction in industrial production processes, and to a method for the fabrication of said bodies.

Polymers are applied in numerous ways and in the most diverse areas of technology. It is thereby often helpful that bodies made of these polymers are surface-structured. This structuring can take place in a physical and/or chemical manner.

The controlled and targeted formation of wrinkles via mechanical processes at the nano and micro levels is known. This was published for the first time in 1998 by Bowden et al. (N. Bowden et al.: 1998; Nature, 393-6681, 146-9).

Since then, there have been many reports about new possibilities for and ways of fabricating this system; emphasis was thereby almost always placed on the advantages of what is referred to as soft lithography over classical, radiation-based lithography, which advantages include mechanical wrinkling. In soft lithography, structures of the order of magnitude and precision of lithographic processes are achieved, but without etching and radiation. This almost always occurs via mechanical tensile and compressive processes with soft substrate materials, hence the name soft lithography (Y. Xia et al. 1998, Science, 37-5, 550-575). The two most important advantages are namely the expenditure of time and money and the potential scalability of wrinkling systems. The former point usually stands up to scrutiny, whereas it has not yet been possible to practically apply and demonstrate the latter.

The disadvantage of the known solutions for wrinkling processes is essentially that polymer surfaces can only be wrinkled on the lower end of the cm² scale.

Furthermore, from DE 10 2012 010 635 A1, a method is known for the 3D structuring and shaping of surfaces made of hard, brittle, and optical materials. For this purpose, the surface of the materials is created using direct ablation by means of an ultrashort pulse laser, and the shaped surface is smoothed by means of a plasma jet.

According to WO2012/031201 A3, a method for producing an anti-fouling surface with a micro- or nano-structured coating is also known. A substrate is thereby stretched, the surface of the stretched substrate is coated, and the stretching strain is then removed, so that the coated surface is compressed. The substrate can thereby be irradiated for the purpose of modification, and the coating of the substrate surface takes place solely be means of initiated chemical vapor deposition (iCVD).

With the known methods for fabricating surface-structured polymer bodies, these bodies can only be prepared with increased effort and inadequate structuring accuracy, and in particular only with an essentially isotropic arrangement of the structuring.

The object of the present invention is to specify surface-structured polymer bodies which have a high structuring accuracy with regard to the dimensions on the surface of the polymer bodies, and to specify a simple and cost-efficient method for the fabrication of said bodies.

The object is attained by the invention disclosed in the claims. Advantageous embodiments are the subject matter of the dependent claims.

In the surface-structured polymer bodies according to the invention, polymer bodies with dimensions of at least ≥100 cm² are present, the surfaces of which are at least partially covered with at least one nano- to micrometer-thick layer, and the layers are physically and/or chemically coupled to the polymer bodies, and the surface of the polymer bodies with the layers is at least partially deformed, wherein the deformation is periodic within a deformation type and the arrangement of multiple different deformation types on a polymer body is anisotropic or isotropic, and wherein the elastic modulus of the material of the polymer body is less than the elastic modulus of the layer materials.

Advantageously, polymer bodies with dimensions of 100 cm² to 100 m² are present.

Likewise advantageously, a layer having a layer thickness between 10 nm and 100 μm is present.

Also advantageously, the surfaces are coated with a layer composite of two to 10 layers on top of one another, wherein the total thickness of all layers is not more than 100 μm.

And also advantageously, the surface of a polymer body is completely or partially coated with a layer or a layer composite of different layer materials on top of or next to one another.

It is also advantageous if the physical coupling of the polymer bodies and layer or layer composite is achieved by mechanical interlocking or by means of van der Waals forces, and if the chemical coupling of the polymer bodies and layer or layer composite is achieved through chemical covalent bonds.

It is furthermore advantageous if the deformation within a deformation type on a polymer body is periodic and anisotropic.

It is likewise advantageous if, with the arrangement of multiple deformation types on a polymer body, the deformation within one arrangement is aligned in a periodic and isotropic manner and if the deformations among the different deformation types are aligned anisotropically to one another.

And it is also advantageous if the polymer bodies comprise multiple deformation types which differ in regard to the periodicity, dimensions, and/or shape of the deformations.

It is also advantageous if the materials of the polymer bodies are elastomers, thermoplastic elastomers, thermoplastics, and/or duromers, or if these materials are at least present on or contained in the polymer body surface that is to be coated.

It is furthermore advantageous if the layer or the layer composite is composed of metallic, polymeric, polymer-composite, ceramic, or vitreous materials.

It is also advantageous if the elastic modulus of the material of the polymer body is at least 1 order of magnitude less than the elastic modulus of the layer materials.

In the method according to the invention for the fabrication of surface-structured polymer bodies, polymer bodies with dimensions of at least ≥100 cm² are subjected to a stretching strain in at least one direction at least above the critical wrinkling stress and maximally up to below the fracture stress of the material of the polymer bodies, the surfaces of the polymer bodies are coated in the strained state with at least one nano- to micrometer-thick layer or layer composite by means of an atmospheric plasma or by means of printing or by means of knife coating, and the stretching strain of the polymer bodies is then released at least in sections, wherein the materials used in the polymer bodies have an elastic modulus which is less than the elastic modulus of the applied layer materials, and wherein the fabrication process is carried out continuously.

Advantageously, the critical wrinkling stress of the material of the polymer bodies is determined according to:

$${σ}_{c} = \frac{{F}_{c}}{hw} = {[ \frac{9}{64} ( \frac{{E}_{s}}{1 - {v}_{s}^{2}} ) {( \frac{{E}_{k}}{1 - {v}_{k}^{2}} )}^{2} ]}^{1 / 3}$$

Likewise advantageously, the layer application is carried out by means of atmospheric plasmas, for example, by means of plasma jet, by means of corona discharge, or by means of dielectric barrier discharge.

Also advantageously, precursor materials of the layer materials are used.

Also advantageously, the layer application is carried out by means of a plasma jet, the plasma activation cross-section of which is beam-shaped, in the shape of a rotating circle, and/or linearly flat.

With the solution according to the invention, it is for the first time possible to specify surface-structured polymer bodies which exhibit a high structuring accuracy in regard to the dimensions on the surface of the polymer bodies, and also to specify a simple and cost-effective method for the fabrication thereof.

This is achieved with surface-structured polymer bodies which, for example, are molded bodies such as injection molded parts or films that are two-dimensional with dimensions of at least ≥100 cm².

The materials of the polymer bodies used must thereby have at least the critical wrinkling stress as a minimum stretching strain. Only polymer materials of this type can be surface-structured according to the invention and can be present as surface-structured polymer bodies according to the invention.

The invention can be used in a particularly advantageous manner for a surface-structuring of polymer bodies with large dimensions of length and width compared to the thickness of said bodies, which dimensions are to be at least ≥100 cm², advantageously also 100 m² or even more. Such large-area surface-structured polymer bodies that are scaled up from the polymer bodies from the prior art and have been fabricated in a continuous process are not yet known to date. Within the scope of the present invention, the scaling-up of the polymer bodies according to the invention is to mean that surface-structured polymer bodies known from the prior art, the surface structuring of which corresponds to the deformation in the solution according to the invention, can be present and fabricated in significantly larger dimensions of length and width as a result of the solution according to the invention.

The surface-structured polymer bodies according to the invention comprise at least partially on their surface at least one nano- to micrometer-thick layer or one layer composite. The layer thickness of the layer or the layer composite is advantageously between 10 nm and 100 μm.

The length and width dimensions of the layer or the layer composite can be equal to or less than the maximum length and width dimensions of the polymer body, whereby the length and width dimensions of the layer or the layer composite can also be less than 100 cm².

In the case of a layer composite, this layer composite can advantageously be composed of two layers, but also up to 10 or 100 or several hundreds of layers on top of one another, wherein the total thickness of all layers is at least one order of magnitude smaller than the thickness of the polymer body.

The surface of the polymer bodies can also be completely or partially covered with one layer or one layer composite, wherein layers or layer composites made of different layer materials can also be arranged on top of and/or next to one another on a polymer body.

The layers or layer composites present according to the invention can, in addition to the surface structuring according to the invention, also comprise functional properties for the entire surface-structured polymer body, for example, they can be hydrophobic and/or oleophobic; electrically conductive or insulating; optically reflective, absorbent, or transmitting.

The layers or layer composites are physically and/or chemically coupled to the polymer bodies. The coupling of the layer materials to the polymer body material can, for example, be achieved by means of ionic bonding, van der Waals forces, chemical covalent bonds, or via mechanical interlocking.

The surface structuring of the polymer bodies takes place essentially through a deformation of the surface-proximate regions of the polymer bodies and the applied layers or layer composites. The surface of the polymer bodies with the layers is thereby at least partially deformed.

According to the invention, the deformation is periodic and advantageously also anisotropic within a deformation type, but can also be isotropic.

Within the scope of this invention, anisotropic deformation is to be understood as meaning that the deformation, at least in regard to the dimensions thereof in at least one direction, shows essentially identical deformations. Within the meaning of the present invention, isotropic deformations are uneven and/or non-identical deformations, at least in regard to the dimensions thereof in multiple or all directions of the deformations.

Multiple different deformation types can also be arranged on a polymer body, in which types the deformation is isotropic or anisotropic. Advantageously, the deformation is also homogeneous within a deformation type, and is likewise advantageously sinusoidal, bisinusoidal, or quadrisinusoidal.

The periodicity can advantageously be 100 nm-10 μm for a wrinkle-like deformation, for example.

The deformation in the case of multiple deformation types on a polymer body is advantageously also periodic and anisotropic within one deformation type, but among the multiple deformation types on a polymer body the different deformation types are also aligned anisotropically to one another or can also be aligned isotropically to one another.

The deformation types can thereby differ with regard to the periodicity, dimensions, and/or shape of the deformations.

Elastomers, thermoplastic elastomers, thermoplastics, and/or duromers can advantageously be present as materials for the polymer bodies, or they are at least present on the polymer body surface that is to be coated.

The layers or layer composites can be made of different polymer materials or metallic or ceramic, inorganic or organic layer materials, and of monolayers of molecules, particles or colloids of these materials.

The selection of the materials for the polymer bodies and layers which together form the surface-structured polymer body according to the invention takes place at least based on the elastic modulus of the respective materials, which is known for all usable materials or can be determined with little effort.

The elastic modulus of the material of the polymer body must thereby be at least 1 order of magnitude less than the elastic modulus of the layer materials.

In the method for the fabrication of surface-structured polymer bodies according to the invention, polymer bodies with dimensions of at least ≥100 cm² in two dimensions are subjected to a stretching strain in at least one direction, at least above the critical wrinkling stress and maximally up to below the fracture stress of the material of the polymer bodies.

At least the critical wrinkling stress of the polymer body material must be reached as a minimum stretching strain of the polymer bodies, which stress can be determined according to:

$${σ}_{c} = \frac{{F}_{c}}{hw} = {[ \frac{9}{64} ( \frac{{E}_{s}}{1 - {v}_{s}^{2}} ) {( \frac{{E}_{k}}{1 - {v}_{k}^{2}} )}^{2} ]}^{1 / 3}$$

Here, ε_{c} stands for the critical wrinkling stress, F_{c} for the corresponding critical force, h and w for the height and width of the polymer body being stretched, Eₛ and Eₖ for the respective elastic moduli of the materials of the polymer body and layer or layer composite, and νₛ and ν_{f} for the accompanying Poisson's ratios.

The stretching can thereby be carried out in at least one direction, or simultaneously in multiple directions. In this manner, multiple different deformation types can be produced at the same time on a polymer body, for example. By stretching the polymer body in only one spatial direction (uniaxial stretching strain), deformations can be produced in the shape of parallel wrinkles in two spatial directions positioned orthogonally to one another (biaxial stretching strain), referred to as herringbone or chevron patterns, which deformations are comparable to fishbone patterns. In addition, stretching strains of the polymer body in two or more directions that are not orthogonal to one another are also possible.

Stretching strains in a uniaxial as well as a biaxial direction also result in more complex deformations that can be composed of sinusoidal wrinkles, which are referred to as bisinusoidal and quadrisinusoidal wrinkles.

An important advantage of the solution according to the invention is that, according to the invention, deformations of this type can be achieved in a continuous process.

After achieving the stretching of the polymer bodies, the surfaces thereof are coated in the strained state with at least one nano- to micrometer-thick layer or a layer composite.

The coating of the polymer bodies thereby occurs by means of an atmospheric plasma, printing, or knife coating.

Advantageously, the coating occurs by means of atmospheric plasmas, for example, by means of plasma jet, by means of corona discharge, or by means of dielectric barrier discharge.

The layer materials or precursors of the layer materials can thereby be used as starting materials for the coating process. In particular, glass-forming precursors are used as precursors for the application by means of an atmospheric plasma. The precursors are thereby fragmented in the plasma during the plasma coating (ionized, radicalized, and at least pre-polymerized), and the layer on the surface is created by recombination.

Polydimethylsiloxane (PDMS), ethylene propylene diene monomer rubber (EPDM) or hydrogenated acrylonitrile butadiene rubber (HNBR), for example, can be used as materials for the polymer bodies, and hexamethyldisiloxane (HMDSO), hexamethyldisilazane (HMDSN), tetramethyldisiloxane (TMDSO), hexamethyltrisiloxane (HMTSO), tetramethyl orthosilicate (TMOS) or tetraethyl orthosilicate (TEOS), for example, can be used as precursors for the coating. The elastic moduli of PDMS, EPDM, or HNBR are each less than the elastic moduli of HMDSO, HMDSN, TMDSO, HMTSO, TMOS, or TEOS.

Likewise, layers and layer composites can be formed directly in the material of the polymer body, that is, can be created in situ. For this purpose, polymeric materials such as silicones are required, which materials are characterized by their glass-forming property, for example, PDMS. By means of oxidation, radical formation, ionization, or reduction, the material undergoes a metamorphosis from a polymeric to a vitreous material. If this transformation takes place only in proximity to the surface, a layer, a layer-like film, or a layer composite is created as a result.

The use of atmospheric plasmas or printing or knife coating for the coating of polymer bodies and a subsequent deformation of at least the surface region and of the applied layer or layer composites is not previously known from the prior art.

Materials that can be fed into a plasma and processed under atmospheric conditions can be used as layer materials. For example, these can be metallic, polymeric, polymer-composite, ceramic, or vitreous materials.

The layer application can thereby take place in that the stretched polymer bodies are guided under the tools for the layer application, or the tools for the layer application are guided over the stretched polymer bodies.

Advantageously, the stretched polymer bodies are guided under the tools for the layer application, whereby very uniform activation cross-sections and a high structuring homogeneity are achieved.

For practical purposes, what are referred to as roll-to-roll processes are used for the layer application with the use of atmospheric plasmas, which processes comprise stretching devices for the polymer bodies that stretch the polymer bodies, that is, keep them under tension, and with which devices the polymer bodies are rolled up or unrolled under the constant stretching strain.

For the surface modification of polymer bodies according to the invention, polymer bodies are used in which the elastic modulus of the polymer body material is less, advantageously at least 1 order of magnitude less, than the elastic modulus of the applied layer materials.

Following the application of the coating to the polymer bodies, the stretching strain of the polymer bodies is removed at least in sections, that is, for example, the mechanical and/or thermal tension or tension due to swelling processes of the polymer bodies is released.

It is particularly important for the solution according to the invention that the fabrication process is carried out continuously.

Thus, according to the invention, large-area to very large-area surface-modified polymer bodies can be continuously fabricated in an ongoing production process, which had not been achieved previously according to the prior art.

With the method according to the invention, surface-structured polymer bodies according to the invention can be fabricated which exhibit a high structuring accuracy with regard to the dimensions on the surface of the polymer bodies. On the one hand, large areas of the polymer bodies up to the square-meter scale can thereby be surface-structured simultaneously and, with regard to the dimensions thereof and the shapes of the deformation, homogeneous structuring can thereby be achieved on the nm scale to the μm scale.

It is further advantageous that not only anisotropic structures can be fabricated, but also isotropic structures at the same time on a polymer body.

It is likewise an advantage of the solution according to the invention that the applied layer or the layer composite comprises functional properties, such as for example increased or reduced hydrophilicity, electrical conductivity or electrical insulation; increased or reduced optical activity, such as reflection, absorption or transmission; increased chemical and mechanical resistance; and increased or reduced static and kinetic friction; or that the properties of the applied layers or layer composites have been advantageously influenced by the parameters of the layer application.

In contrast to solutions from the prior art, anisotropic as well as isotropic structuring of the surface of polymer bodies can be achieved in a targeted manner with the solution according to the invention.

According to the invention, with the use of plasma-assisted methods for coating, monomers of the precursors can also be radicalized, applied to the surface, and polymerized. With the use of plasma-assisted methods, molecules can be used which can be polymerized not only radically or ionically. Here, additional physical and chemical processes play a role, which processes also take place via a fragmentation and recombination of molecules and thus allow other cross-links than merely polymerization processes.

The invention is explained below in greater detail with the aid of several exemplary embodiments.

### EXAMPLE 1

A 100×20×0.025 cm film of polydimethylsiloxane (PDMS) with an elastic modulus of 2.5 MPa was stretched in a roll-to-roll stretching device. The stretching strain of the film was thereby set to a constant value of 10%. For the coating of the 70×20 cm effectively available area of the polymer film, the film was passed over by a punctiform plasma nozzle (PlasmaTreat GmbH, Steinhagen, Germany) with a diameter of 1 cm. The distance of the nozzle from the sample surface was 10 mm, the rated power of the plasma nozzle was 5.04 kW (280 V at 18 A), the travel speed of the nozzle over the sample was 100 mm/s.

As precursors for the layer deposition, tetraethyl orthosilicate (TEOS) with an elastic modulus of 450 MPa for the resulting layer was fed to the plasma nozzle. By means of the plasma nozzle, a homogeneous 100 nm-thick layer was deposited, which was composed of oligomeric, minimally cross-linked silicate following the deposition.

With the unrolling of the coated polymer film from the last roller of the roll-to-roll stretching device, the stretching strain was discontinued during the continuous process, and a surface-structured polymer film was present.

The surface structuring was composed of anisotropically arranged wrinkles with a periodicity of 1.5 μm and a structure height of 450 nm.

### EXAMPLE 2

A 100×20×0.1 cm film of acrylonitrile butadiene rubber (NBR) with an elastic modulus of 2.3 MPa was stretched in a roll-to-roll stretching device. The stretching strain of the film was thereby set to a constant value of 8%. The for the coating of the 70×20 cm effectively available area of the polymer film, the film was passed over by a rotating plasma nozzle (PlasmaTreat GmbH, Steinhagen, Germany) with a diameter of 0.5 cm. The distance of the nozzle from the sample surface was 16 mm, the rated power of the plasma nozzle was 4.77 kW (265 V at 18 A), the travel speed of the nozzle over the sample was 100 mm/s.

As a precursor for the layer deposition, hexamethyldisiloxane (HMDSO) with an elastic modulus of 250 MPa for the resulting layer was fed to the plasma nozzle. The deposition rate of the precursor was varied between 4 and 120 g/h.

By means of the plasma nozzle, a layer of varying thickness between 5 and 200 nm was deposited, which was composed of oligomeric, minimally cross-linked silicate following the deposition.

With the unrolling of the coated polymer film from the last roller of the roll-to-roll stretching device, the stretching strain was discontinued during the continuous process, and a surface-structured polymer film was present.

The surface structuring was composed of anisotropically arranged wrinkles with a periodicity between 350 mm and 3.75 μm and a structure height of 100 nm and 1.15 μm nm.

### EXAMPLE 3

A 100×50×0.0025 cm film of polydimethylsiloxane (PDMS) with an elastic modulus of 2.5 MPa was set out on a base paper with a longitudinal pre-strain of 15%. The 95×50 cm area of the polymer film effectively available for the coating was subjected to a plasma treatment with a dielectric barrier discharge (DBD) (4-part DBD—Fraunhofer IST, Braunschweig, Germany). The distance of the electrode to the sample surface was set to 0.2 mm, the rated power of the DBD was 600 W, the unrolling and rolling-up speed was 0.5 m/min.

As a precursor for the layer deposition, tetramethyldisiloxane (TMDSO) with an elastic modulus of 300 MPa for the resulting layer was used. The deposition rate of the precursor was set to 7 L/m by means of a gas transport, which corresponds to a theoretical deposition rate of ˜3 g/h. After the unrolling of the coated polymer film from the last roller of the roll-to-roll DBD device, the stretching strain was discontinued, and a surface-structured polymer film was present.

The surface structuring was composed of anisotropically arranged wrinkles with a periodicity between 2.5 μm and 7 μm and a structure height between 450 nm and 2 μm

### EXAMPLE 4

A 20×10×0.0075 cm film of polydimethylsiloxane (PDMS) with an elastic modulus of 2.4 MPa was set out on a base paper with a longitudinal pre-strain of 20%. A UV cross-linkable resin was imprinted on the PDMS using a 3D printing method and cured at 80° C. for 30 min. The layer obtained had an elastic modulus of 1.2 GPa at a thickness of 20 μm. After the printing, the stretching strain of the sample was released.

The surface structuring was composed of anisotropically arranged wrinkles with a periodicity of 475 μm and a structure height of 120 μm.

With the imprinting of a second layer having the same elastic modulus, a total layer thickness of 40 μm was achieved, which resulted in a periodicity of 850μ and a structure height of 200 μm. A third layer resulted in a total layer thickness of 60 μm and a periodicity of 1.15 mm at a structure height of 300 μm.

### EXAMPLE 5

A 40×10×0.2 cm film of ethylene propylene diene monomer rubber (EPDM) with an elastic modulus of 5.7 MPa was stretched in a stretching device. The stretching strain of the film was thereby set to a constant value of 15%. A UV cross-linkable resin was applied to the EPDM using a knife coating method and cured under UV light. The layer obtained had an elastic modulus of 500 MPa at a thickness of 50 μm. After the curing, the stretching strain of the sample was released.

The surface structuring was composed of anisotropically arranged wrinkles with a periodicity of 200 μm and a structure height of 20 μm.

### EXAMPLE 6

1) Bisinusoidal and Quadrisinusoidal Wrinkling

A 100×10×0.050 cm film of polydimethylsiloxane (PDMS) with an elastic modulus of 2.1 MPa was stretched in a roll-to-roll stretching device. The stretching strain of the film was thereby set to a constant value of 85%. For the coating of the polymer film, the film was passed over by a punctiform plasma nozzle (PlasmaTreat GmbH, Steinhagen, Germany) with a diameter of 1 cm. The distance of the nozzle from the sample surface was 10 mm, the rated power of the plasma nozzle was 6.3 kW (350 V at 18 A), the travel speed of the nozzle over the sample was 25 mm/s.

The PDMS was oxidized in situ in order to thus create the layer. The layer obtained had a thickness of 180 nm at an average elastic modulus of 150 MPa for the resulting layer.

With the unrolling of the coated polymer film from the last roller of the roll-to-roll stretching device, the stretching strain was discontinued during the continuous process, and a surface-structured polymer film was present.

The surface structuring was composed of anisotropically arranged bisinusoidal wrinkles with a periodicity of 1.5 μm and a structure height of 650 nm for the deep amplitude and 125 nm for the flat amplitude.

If the film is stretched to 95%, anisotropically arranged quadrisinusoidal wrinkles are obtained with a periodicity of 1.45 μm and a structure height of 750 nm for the deep amplitude, 450 nm for the middle amplitude, and 75 nm of the flat amplitude.

2) Biaxial Stretching Orthogonal to One Another

A 100×10×0.125 cm film of polydimethylsiloxane (PDMS) with an elastic modulus of 2.0 MPa was stretched longitudinally in a roll-to-roll stretching device and, transversely thereto, in two sliding film stretchers made of polytetrafluoroethylene (PTFE). The stretching strain of the film was thereby set to a constant value of 5% in both directions orthogonal to one another. For the coating of the polymer film, the film was passed over by a circularly rotating plasma nozzle (PlasmaTreat GmbH, Steinhagen, Germany) with a diameter of 2.5 cm. The distance of the nozzle from the sample surface was 13 mm, the rated power of the plasma nozzle was 6.3 kW (350 V at 18 A), the travel speed of the nozzle over the sample was 50 mm/s.

The PDMS was oxidized in situ in order to thus create the layer. The layer obtained had a thickness of 110 nm at an average elastic modulus of 85 MPa for the resulting layer.

With the unrolling of the coated polymer film from the last roller of the roll-to-roll stretching device, the stretching strain was discontinued during the continuous process, and a surface-structured polymer film was present.

The surface structuring was composed of anisotropically arranged wrinkles that were directed orthogonally to one another in regular patterns, also referred to as a chevron or herringbone structure. A periodicity of 1.4 μm and a structure height of 80 nm were present in both spatial directions.

1. Surface-structured polymer bodies in which polymer bodies with dimensions of at least ≥100 cm² are present, the surfaces of which are at least partially covered with at least one nano- to micrometer-thick layer, and the layers are physically and/or chemically coupled to the polymer bodies, and the surface of the polymer bodies with the layers is at least partially deformed, wherein the deformation is periodic within a deformation type and the arrangement of multiple different deformation types on a polymer body is anisotropic or isotropic, and wherein the elastic modulus of the material of the polymer body is less than the elastic modulus of the layer materials.

2. The surface-structured polymer bodies according to claim 1 in which polymer bodies with dimensions of 100 cm² to 100 m² are present.

3. The surface-structured polymer bodies according to claim 1 in which a layer with a layer thickness between 10 nm and 100 μm is present.

4. The surface-structured polymer bodies according to claim 1 in which the surfaces are coated with a layer composite of two to 10 layers on top of one another, wherein the total thickness of all layers is not more than 100 μm.

5. The surface-structured polymer bodies according to claim 1 in which the surface of a polymer body is completely or partially coated with a layer or a layer composite of different layer materials on top of or next to one another.

6. The surface-structured polymer bodies according to claim 1 in which the physical coupling of the polymer bodies and layer or layer composite is achieved by mechanical interlocking or by means of van der Waals forces, and the chemical coupling of the polymer bodies and layer or layer composite is achieved through chemical covalent bonds.

7. The surface-structured polymer bodies according to claim 1 in which the deformation within a deformation type on a polymer body is periodic and anisotropic.

8. The surface-structured polymer bodies according to claim 1 in which, with the arrangement of multiple deformation types on a polymer body, the deformation within one arrangement is aligned in a periodic and isotropic manner and the deformations among the different deformation types are aligned anisotropically to one another.

9. The surface-structured polymer bodies according to claim 1 in which the polymer bodies comprise multiple deformation types which differ in regard to the periodicity, dimensions, and/or shape of the deformations.

10. The surface-structured polymer bodies according to claim 1 in which the materials of the polymer bodies are elastomers, thermoplastic elastomers, thermoplastics, and/or duromers, or these materials are at least present at or contained in the polymer body surface that is to be coated.

11. The surface-structured polymer bodies according to claim 1 in which the layer or the layer composite is composed of metallic, polymeric, polymer-composite, ceramic, or vitreous materials.

12. The surface-structured polymer bodies according to claim 1 in which the elastic modulus of the material of the polymer body is at least 1 order of magnitude less than the elastic modulus of the layer materials.

13. A method for the fabrication of surface-structured polymer bodies in which polymer bodies with dimensions of at least ≥100 cm² are subjected to a stretching strain in at least one direction at least above the critical wrinkling stress and maximally up to below the fracture stress of the material of the polymer bodies, the surfaces of the polymer bodies are coated in the strained state with at least one nano- to micrometer-thick layer or layer composite by means of an atmospheric plasma or by means of printing or by means of knife coating, and the stretching strain of the polymer bodies is then released at least in sections, wherein the elastic modulus of the materials used in the polymer bodies is less than the elastic modulus of the applied layer materials, and wherein the fabrication process is carried out continuously.

14. The method according to claim 13 in which the critical wrinkling stress of the material of the polymer bodies is determined according to:
$${σ}_{c} = \frac{{F}_{c}}{hw} = {[ \frac{9}{64} ( \frac{{E}_{s}}{1 - {v}_{s}^{2}} ) {( \frac{{E}_{k}}{1 - {v}_{k}^{2}} )}^{2} ]}^{1 / 3}$$

15. The method according to claim 13 in which the layer application is carried out by means of atmospheric plasmas, for example, by means of plasma jet, by means of corona discharge, or by means of dielectric barrier discharge.

16. The method according to claim 13 in which precursor materials of the layer materials are used.

17. The method according to claim 13 in which the layer application is carried out by means of a plasma jet, the plasma activation cross-section of which is beam-shaped, in the shape of a rotating circle, and/or linearly flat.
